(19) United States
(12) Patent Application Publication
(10) Pub. No.: US 2026/0120651 A1
(43) Pub. Date: Apr. 30, 2026

(54) DATA DRIVER AND DISPLAY DEVICE INCLUDING THE SAME

(71) Applicant: LG Display Co., Ltd., Seoul (KR)

(72) Inventor: Daehwan KIM, Paju-si (KR)

(73) Assignee: LG Display Co., Ltd., Seoul (KR)

(21) Appl. No.: 19/229,771

(22) Filed: Jun. 5, 2025

(30) Foreign Application Priority Data
Oct. 25, 2024 (KR) 10-2024-0147315

(51) Int. Cl. G09G 3/3275; G09G 3/20; G09G 3/3233

(52) U.S. Cl. CPC G09G 3/3275; G09G 3/3233; G09G 3/2074; G09G 2300/0819; G09G 2300/0861; G09G 2310/027; G09G 2310/0286; G09G 2310/0291; G09G 2310/06; G09G 2320/0673

(57) ABSTRACT

A data driver and a display device including the data driver are discussed. The data driver can include a register unit configured to sample and output image data input sequentially in each horizontal period, a latch unit configured to latch the image data output from the register unit and output the image data in synchronization with a latch output control signal, a digital-to-analog converter configured to convert the image data output from the latch unit into a gamma compensation voltage so as to generate data voltages, a plurality of output buffers configured to sequentially output the data voltages generated by the digital-to-analog converter to data lines, buffer switching elements connecting the output buffers to the data lines, respectively, in response to a source output enable signal, and a charge share circuit configured to control a connection between at least one charge share line and the data lines.

### CROSS-REFERENCE TO RELATED APPLICATION

The present application claims priority to Korea Patent Application No. 10-2024-0147315, filed in the Republic of Korea on Oct. 25, 2024, the entire contents of which is hereby expressly incorporated by reference into the present application.

### BACKGROUND

### Field

The present disclosure relates to a data driver and a display device including the same.

### Discussion of the Related Art

With the development of an information society, various types of display devices have been developed. Recently, various types of display devices such as liquid crystal display (LCD), plasma display panel (PDP), and organic light emitting display (OLED) devices have been utilized.

A display device can include a display panel on which pixels are disposed, a data driver configured to apply a data voltage to pixels, a gate driver configured to apply a gate signal to pixels, and a timing controller configured to control an operation timing of the data driver and the gate driver.

As the size of the display device becomes greater and the resolution thereof rises, a charge share operation method has been researched and developed so as to decrease a heating value and power consumption of the data driver and improve reliability. In the charge share driving method, it is ensured that sufficient charging time and charging amount of each data line is secured by supplying an average voltage of data voltages and electrically connecting data lines before outputting a data voltage in each horizontal period and when changing a polarity.

### SUMMARY OF THE DISCLOSURE

Embodiments of the present disclosure provide a data driver configured to perform a charge share operation according to a grayscale value of image data and a display device including the same.

Embodiments of the present disclosure provide a data driver configured to perform a charge share operation in a display device in which a polarity of a data voltage is not inverted, and a display device including the same.

Embodiments of the present disclosure provide a data driver configured to operate in a charge share mode by defining a plurality of grayscale regions and electrically connecting data lines to which a data voltage in the same grayscale region is to be output, and a display device including the same.

Embodiments of the present disclosure provide a data driver and a display device including the same, which address the limitations and disadvantages associated with the related art.

One embodiment of the present disclosure provides a data driver, including: a register unit configured to sample and output image data input sequentially in each horizontal period; a latch unit configured to latch the image data output from the register unit and output the image data in synchronization with a latch output control signal; a digital-to-analog converter configured to convert the image data output from the latch unit into a gamma compensation voltage so as to generate data voltages; a plurality of output buffers configured to sequentially output the data voltages generated by the digital-to-analog converter to data lines; buffer switching elements connecting the output buffers to the data lines, respectively, in response to a source output enable signal; a charge share circuit configured to control a connection between at least one charge share line and the data lines; and a calculation unit configured to output a control signal configured to control the charge share circuit based on a grayscale value of the image data output by the latch unit.

According to aspects of the present disclosure, the charge share circuit can include: the at least one charge share line; and at least one charge share switching element connected between the at least one charge share line and the data lines, and each of the charge share switching element can connect a corresponding data line to a corresponding charge share line in response to the control signal in a turn-on level.

According to aspects of the present disclosure, the each of the charge share switching element can be connected between the corresponding data line and the corresponding charge share line, and can be configured as a transistor having a gate electrode thereof connected to the calculation unit and configured to receive the control signal.

According to aspects of the present disclosure, the calculation unit can select at least one data line to operate in a charge share mode based on the grayscale value of the image data, and output the control signal in the turn-on level to charge share switching elements connected to the selected data line.

According to aspects of the present disclosure, the calculation unit can define a plurality of grayscale regions, select image data of which the grayscale value is included in a same grayscale region, and control the charge share switching elements to connect data lines to which the selected image data is to be applied to a same charge share line.

According to aspects of the present disclosure, the calculation unit can select image data of which the grayscale value is included in a high grayscale region and a low grayscale region, and control the charge share switching elements to connect the data lines to which the selected image data is to be applied to a same charge share line.

According to aspects of the present disclosure, when a grayscale value of a previous image data and a grayscale value of a next image data among the image data input sequentially are included in different grayscale regions, the calculation unit can operate a data line to which the next image data is to be applied in the charge share mode.

According to aspects of the present disclosure, when a grayscale value of a previous image data is included in a high grayscale region and a grayscale value of a next image data is included in a low grayscale region among the image data input sequentially, the calculation unit can operate a data line to which the next image data is to be applied in the charge share mode.

According to aspects of the present disclosure, when a grayscale value of a previous image data is included in a low grayscale region and a grayscale value of a next image data is included in a high grayscale region among the image data input sequentially, the calculation unit can operate a data line to which the next image data is to be applied in the charge share mode.

According to aspects of the present disclosure, in an (n−1)th horizontal period where n is a natural number equal to or greater than 2, data voltages corresponding to an (n−1)th image data can be applied to the data lines, in a charge share period, a voltage can be redistributed among the data lines connected to the same charge share line, and in an n-th horizontal period, data voltages corresponding to a difference between a voltage corresponding to an n-th image data and the redistributed voltage can be applied to the data lines.

According to aspects of the present disclosure, in the charge share period, the data lines connected to the same charge share line can be charged to an average value of voltages charged to the data lines connected to the same charge share line in the (n−1)th horizontal period.

According to aspects of the present disclosure, in the (n−1)th horizontal period, the source output enable signal in a turn-on level can be applied, in the charge share period, the source output enable signal in a turn-off level can be applied, and in the n-th horizontal period, the source output enable signal in the turn-on level can be applied.

According to aspects of the present disclosure, at least one charge share line can be provided in correspondence with a quantity of the plurality of grayscale regions.

Another embodiment of the present disclosure provides a display device, including: a display panel having an arrangement of pixels; a data driver configured to apply data voltages to the pixels through data lines; a gate driver configured to apply scan signals to the pixels through scan lines; and a timing controller configured to apply image data and a data driving control signal to the data driver, the data driver can include: a register unit configured to sample and output the image data; a latch unit configured to latch the image data output from the register unit and output the image data in synchronization with a latch output control signal; a digital-to-analog converter configured to convert the image data output from the latch unit into a gamma compensation voltage so as to generate data voltages; a plurality of output buffers configured to sequentially output the data voltages generated by the digital-to-analog converter to the data lines; buffer switching elements connecting the output buffers to the data lines, respectively, in response to a source output enable signal; a charge share circuit having charge share switching elements configured to control a connection between at least one charge share line and the data lines; and a calculation unit configured to output a control signal configured to control the charge share switching elements based on a grayscale value of the image data output by the latch unit.

According to aspects of the present disclosure, the calculation unit can define a plurality of grayscale regions, select image data of which the grayscale value is included in a same grayscale region, and control the charge share switching elements to connect data lines to which the selected image data is to be applied to a same charge share line.

According to aspects of the present disclosure, the calculation unit can select image data of which the grayscale value is included in a high grayscale region and a low grayscale region, and control the charge share switching elements to connect the data lines to which the selected image data is to be applied to a same charge share line.

According to aspects of the present disclosure, when a grayscale value of a previous image data and a grayscale value of a next image data among the image data input sequentially can be included in different grayscale regions, the calculation unit can control the charge share switching elements to connect a data line to which the next image data is to be applied to one among the charge chare lines.

According to aspects of the present disclosure, when a grayscale value of a previous image data is included in a high grayscale region and a grayscale value of a next image data is included in a low grayscale region among the image data input sequentially, the calculation unit can control the charge share switching elements to connect a data line to which the next image data is to be applied to one among the charge share lines, and when a grayscale value of a previous image data is included in a low grayscale region and a grayscale value of a next image data is included in a high grayscale region among the image data input sequentially, the calculation unit can control the charge share switching elements to connect a data line to which the next image data is to be applied to one among the charge share lines.

A data driver and a display device including the same according to the embodiments of the present disclosure allow not only a display device in which a polarity of a data voltage is inverted, for example, a liquid crystal display device, but also a display device in which a polarity of a data voltage is not inverted, for example, an organic light emitting display (OLED) device to perform a charge share operation.

A data driver and a display device including the same according to the embodiments of the present disclosure allow to improve the power consumption by performing a charge share operation with respect to the data lines according to a grayscale value of a data voltage.

A data driver and a display device including the same according to the embodiments of the present disclosure can reduce a heating value of the data driver and increase reliability in a large-scale and high-resolution condition.

### BRIEF DESCRIPTION OF THE DRAWINGS

FIG. 1 is a block diagram illustrating a configuration of a display device according to embodiments of the present disclosure.

FIG. 2 is a circuit diagram of an example of a pixel according to embodiments of the present disclosure.

FIG. 3 is a timing diagram illustrating an example of a method for operating a pixel illustrated in FIG. 2.

FIG. 4 is a block diagram illustrating an example of a configuration of a source drive IC according to a first embodiment of the present disclosure.

FIG. 5 is a block diagram illustrating an example of a configuration of a source drive IC according to a second embodiment of the present disclosure.

FIG. 6 is a diagram illustrating an example of grayscale regions according to embodiments of the present disclosure.

FIG. 7 is a waveform diagram illustrating an example of signals applied to a pixel and a source drive IC according to embodiments of the present disclosure.

FIG. 8 is a diagram illustrating an example of changes of grayscale values of data voltages between horizontal periods.

FIG. 9 is a diagram illustrating an example of an operating state of a charge share circuit according to embodiments of the present disclosure shown in FIG. 8.

FIG. 10 is a diagram illustrating another example of an operating state of a charge share circuit according to embodiments of the present disclosure shown in FIG. 8.

FIGS. 11 to 14 are diagrams illustrating an effect of improving power consumption according to a charge share operation.

FIG. 15 is a block diagram illustrating an example of a configuration of a source drive IC according to a third embodiment of the present disclosure.

### DETAILED DESCRIPTION OF THE EMBODIMENTS

Details of some implementations are included in the following description and the accompanying drawings.

The merits and characteristics of the present disclosure and a method for achieving the merits and characteristics will become more apparent from the embodiments described in detail in conjunction with the accompanying drawings. However, the present disclosure is not limited to the disclosed embodiments, but can be implemented in various different ways. In the below description, when a part is referred to as being “connected to” another part, it can be directly connected to the other part, or it can be electrically connected to the other part with another intervening element inserted therebetween. In addition, parts irrelevant to the present disclosure are omitted in the attached drawings for clarity of description, and like reference numerals denote like elements throughout the attached drawings and the written description.

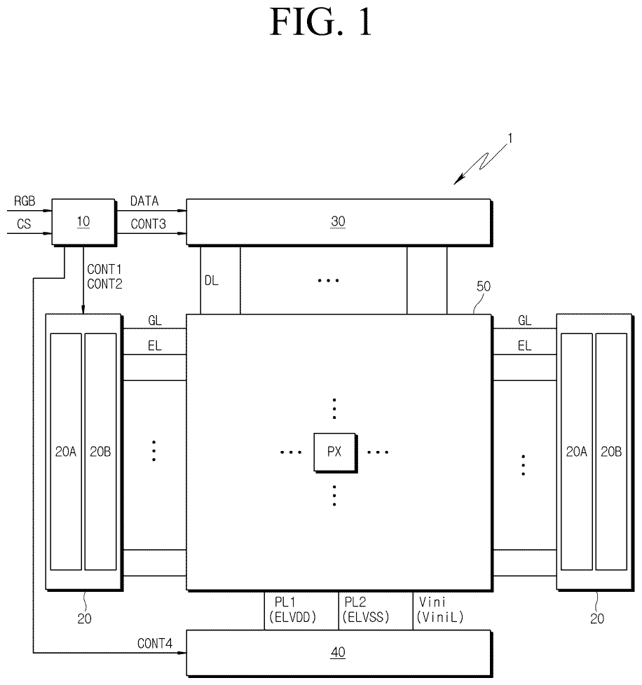

FIG. 1 is a block diagram illustrating a configuration of a display device according to embodiments of the present disclosure.

Referring to FIG. 1, a display device 1 includes a timing controller 10, a gate driver 20, a data driver 30, a power supply unit 40, and a display panel 50.

The timing controller 10 can control an operation timing of the gate driver 20 and the data driver 30. The timing controller 10 can receive a video signal RGB and a control signal CS from an external host system and the like. The video signal RGB can include a plurality of grayscale data. The control signal CS can include, for example, a horizontal synchronization signal, a vertical synchronization signal and a main clock signal.

The timing controller 10 processes the video signal RGB and the control signal CS to be suitable to operational conditions of the display panel 50, and can generate and output image data DATA, a gate driving control signal CONT1, an emission driving control signal CONT2, a data driving control signal CONT3, and a power supply control signal CONT4.

The gate driver 20 can include a scan driving circuit 20A configured to generate scan signals based on signals output from the timing controller 10. The scan driving circuit 20A can provide the generated scan signals to the pixels PX through a plurality of scan lines GL. In an embodiment, one pixel PX can be configured to receive a plurality of scan signals having different waveforms. In such an embodiment, the scan driving circuit 20A can provide the plurality of scan signals to the pixels PX through the scan lines GL corresponding thereto, respectively.

The gate driver 20 can further include a light emission driving circuit 20B configured to generate light emission control signals based on the signals output from the timing controller 10. The light emission driving circuit 20B can provide the generated light emission control signals to the pixels PX through light emission lines EL.

The gate driver 20 can be configured in a Gate-In-Panel form in which the gate driver 20 is mounted on the display panel 50. The gate driver 20 can be disposed on one side of the display panel 50, or on both sides (for example, left and right sides) of the display panel 50 as illustrated. According to a driving method, a panel design manner, and the like, the gate driver 20 can be disposed on both sides (for example, left and right sides) of the display panel 50, or can be connected to two or more side surfaces among four side surfaces of the display panel 50.

The data driver 30 can generate data signals based on the data driving control signal CONT3 and image data DATA output from the timing controller 10. In an embodiment, the data driving control signal CONT3 can include a source output enable signal, a latch output control signal, and information instructing a data packet processing option (for example, an equalizing level, a reception resistance, and the like). The data driver 30 can provide the generated data signals to the pixels PX through a plurality of data lines DL.

The data driver 30 can include at least one source drive IC. The source drive IC can be mounted in a flexible film in a chip-on-film (COF) or chip-on-plastic (COP) manner to be connected to one side of the display panel 50.

The power supply unit 40 can generate a high potential driving voltage ELVDD and a low potential driving voltage ELVSS to be provided to the display panel 50 based on the power supply control signal CONT4. The power supply unit 40 can provide the generated driving voltages ELVDD and ELVSS to the pixels PX through corresponding power lines PL1 and PL2. In addition, the power supply unit 40 can further generate an initialization voltage Vini required for driving the pixel PX, and provide it to the pixels PX through a corresponding voltage line ViniL.

On the display panel 50, a plurality of pixels PX (or referred to as sub-pixels) are disposed. The pixels can be disposed, for example, in a matrix form on the display panel 50. The pixels disposed in one pixel row are connected to the same scan line GL and light emission line EL, and the pixels disposed in one pixel column are connected to the same data line DL. The pixels PX can emit light at luminance corresponding to a data signal and a scan signal supplied through the scan line GL and the data line DL in response to a light emission control signal applied through the light emission line EL.

In an embodiment, each pixel PX can display one color among red, green and blue. In another embodiment, each pixel PX can display one color among cyan, magenta and yellow. In various embodiments, each pixel PX can display one color among red, green, blue and white.

In FIG. 1, the gate driver 20 and the data driver 30 are illustrated to be separate components from the display panel 50, however, at least one among the gate driver 20 and the data driver 30 can be configured in an In-Panel manner of integrating into the display panel 50. For example, the gate driver 20 can be integrated into the display panel 50 according to a Gate-In-Panel (GIP) manner.

The timing controller 10, the gate driver 20, the data driver 30 and the power supply unit 40 can be configured as separate Integrated Circuits (IC) or at least some parts thereof together can be integrated into and form the Integrated Circuit. For example, the timing controller 10, the data driver 30, and the power supply unit 40 can be configured as a driving chip in an Integrated Circuit (IC) form. The driving chip can be implemented, for example, as a Flexible Printed Circuit Board (FPCB) form.

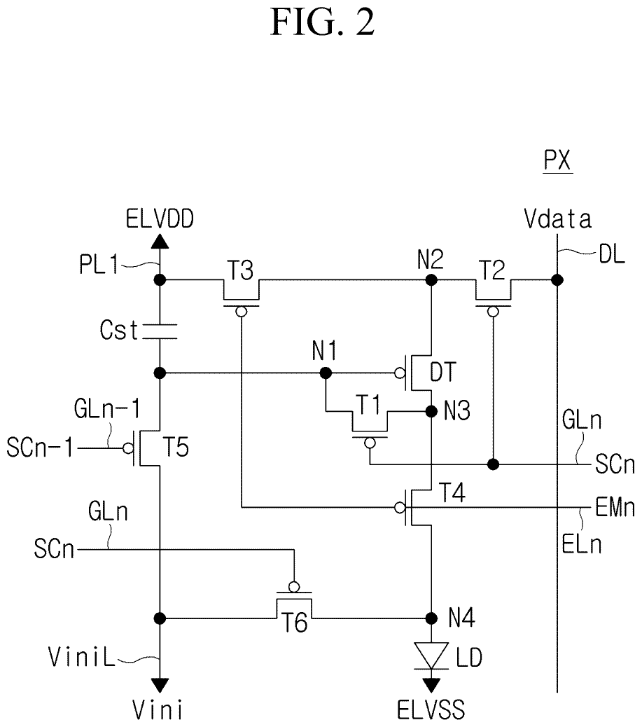

FIG. 2 is a circuit diagram of a pixel according to embodiments of the present disclosure. In FIG. 2, an example of a pixel PX disposed in an n-th pixel row is illustrated.

Referring to FIG. 2, the pixel PX according to embodiments of the present disclosure can include a driving transistor DT, a light emitting diode LD connected to the driving transistor DT, and a control circuit configured to control an amount of a driving current to be applied to the light emitting diode LD through the driving transistor DT. For example, the control circuit can include first to sixth transistors T1 to T6, and a storage capacitors Cst.

A first electrode of the driving transistor DT is configured to receive a high potential driving voltage ELVDD through a second node N2 (connected to a high potential driving voltage line PL1), and a second electrode thereof is connected to a third node N3. A gate electrode of the driving transistor DT is connected to a first node N1. The driving transistor DT can be turned on according to a voltage applied to the first node N1 and can control an amount of the driving current flowing to the light emitting diode LD.

The first electrode of the first transistor T1 is connected to the a gate electrode of the driving transistor DT through the first node N1, and the second electrode thereof is connected to the second electrode of the driving transistor DT through the third node N3. A gate electrode of the first transistor T1 can be connected to an n-th scan line GLn and can receive an n-th scan signal SCn. The first transistor T1 can be turned on according to the n-th scan signal SCn applied to the n-th scan line GLn, and can connect the gate electrode of the driving transistor DT and the second electrode to each other. Such a first transistor T1 can be referred to as a compensation transistor.

A first electrode of the second transistor T2 is connected to the data line DL, and a second electrode thereof is connected to the first electrode of the driving transistor DT through the second node N2. A gate electrode of the second transistor T2 can be connected to an n-th scan line GLn and can receive an n-th scan signal SCn. The second transistor T2 can be turned on according to the n-th scan signal SCn applied to the n-th scan line GLn, and can deliver a data voltage Vdata applied to a data line DL to the second node N2. Such a second transistor T2 can be referred to as a switching transistor.

A first electrode of the third transistor T3 is configured to receive a high potential driving voltage ELVDD (connected to a high potential driving voltage line PL1), and a second electrode thereof is connected to the driving transistor DT through the second node N2. A gate electrode of the third transistor T3 can be connected to the light emission line EL and can receive a light emission control signal EMn. The third transistor T3 can connect the high potential driving voltage line PL1 and the driving transistor DT to each other in response to the light emission control signal EMn applied to the light emission line ELn.

A first electrode of a fourth transistor T4 can be connected to the driving transistor DT through the third node N3, and a second electrode thereof can be connected to the light emitting diode LD through a fourth node N4. A gate electrode of the fourth transistor T4 can be connected to the light emission line ELn, and can receive the light emission control signal EMn. The fourth transistor T4 can connect the driving transistor DT and the light emitting diode LD to each other in response to the light emission control signal EMn applied to the light emission line ELn.

When the third transistor T3 and the fourth transistor T4 are turned on, a current path is formed between the high potential driving voltage ELVDD and the low potential driving voltage ELVSS, and a driving current flows to the light emitting diode LD, thereby the light emitting diode LD can emit light. Such third transistor T3 and the fourth transistor T4 can be referred to as light emitting transistors.

A first electrode of a fifth transistor T5 is configured to receive the initialization voltage Vini (connected to the initialization voltage line ViniL), and a second electrode thereof is connected to the first node N1. A gate electrode of the fifth transistor T5 can be connected to a (n−1)th scan line GLn−1 and can receive a (n−1)th scan signal SCn−1. The fifth transistor T2 can be turned on according to the (n−1)th scan signal SCn−1 applied to the (n−1)th scan line GLn−1, and can deliver the initialization voltage Vini to the first node N1. Such a fifth transistor T5 can be referred to as an initialization transistor.

A first electrode of a sixth transistor T6 is configured to receive the initialization voltage Vini (connected to the initialization voltage line ViniL), and a second electrode thereof is connected to an anode electrode of the light emitting diode LD through the fourth node N4. A gate electrode of the sixth transistor T6 can be connected to the n-th scan line GLn and can receive the n-th scan signal SCn. The sixth transistor T6 can be turned on according to the n-th scan signal SCn applied to the n-th scan line GLn, and can deliver the initialization voltage Vini to the anode electrode of the light emitting diode LD. Such a sixth transistor T6 can be referred to as an anode initialization transistor.

The storage capacitor Cst is connected between the first node N1 and the high potential driving voltage ELVDD (the high potential driving voltage line PL1). The storage capacitor Cst can store a voltage corresponding to a voltage difference between the first node N1 and the high potential driving voltage ELVDD.

The anode electrode of the light emitting diode LD can be connected to the fourth node N4, and the cathode electrode thereof can be connected to the low potential driving voltage ELVSS. When the driving transistor DT, the fourth transistor T4, and the fifth transistor T5 are turned on, a current path is formed between the high potential driving voltage ELVDD and the low potential driving voltage ELVSS, and a driving current can flow to the light emitting diode LD. The light emitting diode LD can emit light at luminance corresponding to an amount of the driving current applied thereto.

The pixel PX can be configured as a low temperature poly-silicon (LTPS) thin film transistor. The LTPS thin film transistor includes a gate electrode, a source electrode, and a drain electrode. The LTPS thin film transistor has an active layer formed of poly silicon. Such an LTPS thin film transistor can be configured as a P-type thin film transistor. The LTPS thin film transistor has a high electron mobility, and therefore, has a fast driving characteristic.

However, the present embodiment is not limited thereto. In various other embodiments of the present disclosure, the pixel PX as a whole can be configured as an oxide semiconductor thin film transistor, or can be configured as a hybrid type including both the LTPS thin film transistor and an oxide semiconductor thin film transistor.

The oxide semiconductor thin film transistor includes a gate electrode, a source electrode, and a drain electrode. The oxide semiconductor thin film transistor has an active layer formed of an oxide semiconductor. Here, the oxide semiconductor can be set as an amorphous oxide semiconductor or a crystalline oxide semiconductor. The oxide semiconductor thin film transistor can be configured as an n-type transistor. The oxide semiconductor thin film transistor can be formed through a low temperature process and has a lower charge mobility than that of the low temperature poly-silicon (LTPS) thin film transistor. Such an oxide semiconductor thin film transistor has an excellent off current characteristic.

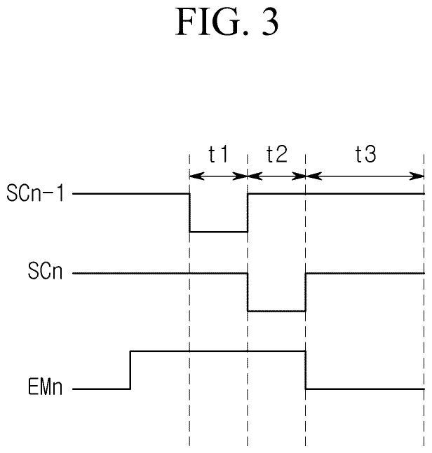

FIG. 3 is a timing diagram illustrating an example of a method for operating the pixel illustrated in FIG. 2.

Referring to FIG. 3, with respect to the method for operating the pixel according to an embodiment of the present disclosure, one frame can include an initialization period t1, a sampling and programming period t2, and a light emission period t3. The pixel PX is initialized in the initialization period t1, a data voltage Vdata in which the threshold voltage Vth of the driving transistor DT is compensated is applied to the first node N1 in the sampling and programming period t2, and the light emitting diode LD can emit light at luminance corresponding to the compensated data voltage Vdata in the light emission period t3.

In the initialization period t1, the (n−1)th scan signal SCn−1 in a turn-on level (for example, a low level) is applied, and the fifth transistor T5 is turned on. Then, the initialization voltage Vini is applied to the first node N1 through the fifth transistor T5 which is turned on, and a voltage of the gate electrode of the driving transistor DT can be initialized. A voltage corresponding to a difference between the high potential driving voltage ELVDD and the initialization voltage Vini can be stored in the storage capacitor Cst.

The n-th scan signal SCn in a turn-on level can be applied in the sampling and programming period t2. Then, the first transistor T1, the second transistor T2, and the sixth transistor T6 can be turned on.

The data voltage Vdata applied to the data line DL through the second transistor T2 which is turned on can be applied to the second node N2, for example, the source electrode of the driving transistor DT.

The gate electrode and the drain electrode of the driving transistor DT can be electrically connected to each other through the first transistor T1 which is turned on. Accordingly, the driving transistor DT in a turn-on state gets into a diode-connected state.

At this instance, because a voltage difference (Vgs=Vini-Vdata) between the gate electrode and the source electrode of the driving transistor DT is greater than the threshold voltage Vth, the driving transistor DT gets into a turn-on state, and forms a current path by the time when the voltage difference Vgs between the gate electrode and the source electrode reaches the threshold voltage Vth. The voltage of the gate electrode of the driving transistor rises to a voltage Vdata-Vth corresponding to a difference between the data voltage Vdata and the threshold voltage Vth. When the driving transistor DT is the P-type, the threshold voltage Vth can be set as a negative value.

Meanwhile, the initialization voltage Vini can be applied to the fourth node N4 through the sixth transistor T6 which is turned on, and the voltage of the anode electrode of the light emitting diode LD can be initialized to the initialization voltage Vini.

In the light emission period t3, the light emission control signal EM in a turn-on level can be applied. Then, the third transistor T3 and the fourth transistor T4 can be turned on.

A current path, which starts from the high potential driving voltage ELVDD, passes through the driving transistor DT, and reaches the light emitting diode LD, is formed through the third transistor T3 and the fourth transistor T4 which are turned on. The driving transistor DT can apply a driving current corresponding to a voltage programmed in the previous period, for example, a voltage Vdata-Vth corresponding to a difference between the data voltage Vdata and the threshold voltage Vth to the light emitting diode LD. Then, the light emitting diode LD can emit light in correspondence with the programmed voltage.

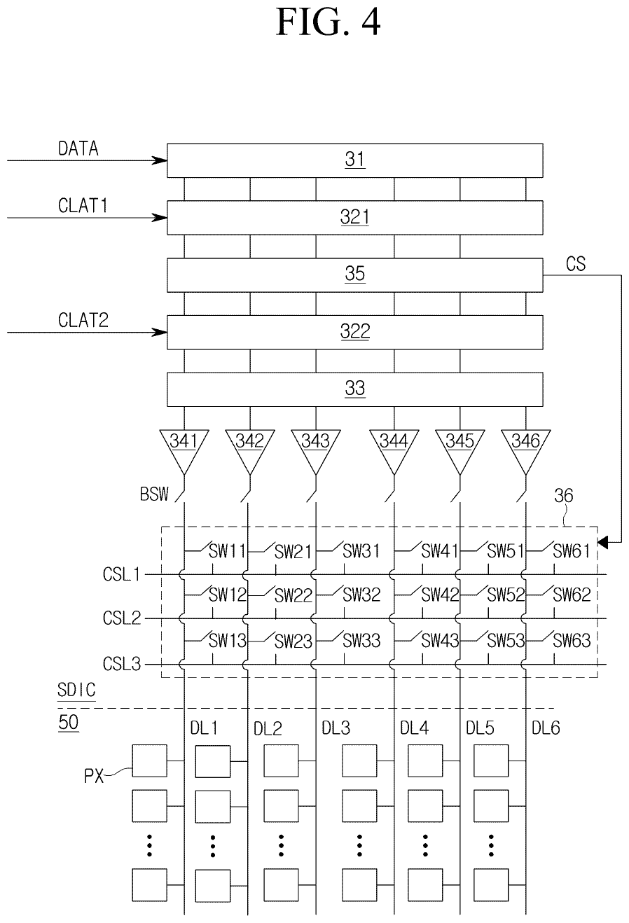

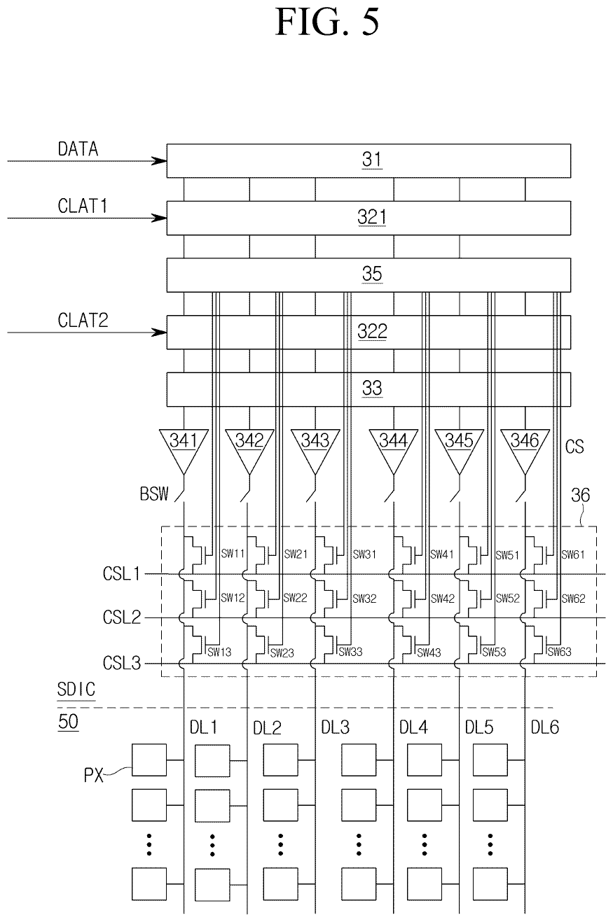

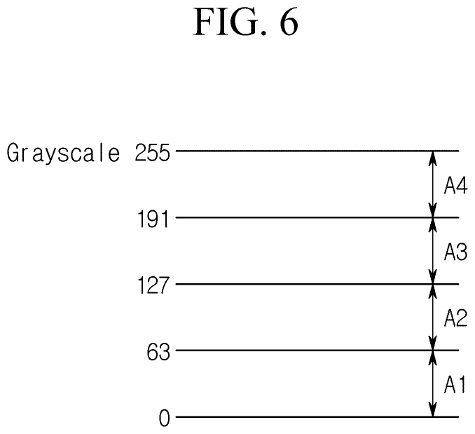

FIG. 4 is a block diagram illustrating an example of a configuration of a source drive IC according to a first embodiment of the present disclosure. FIG. 5 is a block diagram illustrating an example of a configuration of a source drive IC according to a second embodiment of the present disclosure. FIG. 6 is a diagram illustrating an example of grayscale regions according to embodiments of the present disclosure.

Referring to FIG. 4, the source drive IC SDIC can include a register unit 31, latch units 321 and 322, a digital-to-analog converter 33, one or more output buffers 341, 342, 343, 344, 345, and 346, and a buffer switching element BSW.

The register unit 31 can sequentially sample and output bits of image data received from the timing controller 10 (FIG. 1).

The latch units 321 and 322 can latch image data DATA received from the register unit 31 and can output bits of image data DATA simultaneously in synchronization with a latch output control signal CLAT1 and CLAT2 received from the timing controller 10.

In an embodiment, the latch units 321 and 322 can be provided in plural number. For example, the latch units 321 and 322 can include a first latch unit 321 and a second latch unit 322 connected in series.

The first latch unit 321 is connected between the register unit 31 and the second latch unit 322. The first latch unit 321 can include switching elements connected, respectively, to channels of the second latch unit 322. The first latch unit 321 can be turned on according to the first latch output control signal CLAT1, and can output image data DATA stored in the first latch unit 321 to the second latch unit 322.

The second latch unit 322 is connected between the first latch unit 321 and the digital-to-analog converter 33. The second latch unit 322 can include switching elements connected, respectively, to channels of the digital-to-analog converter 33. The second latch unit 322 can be turned on according to the second latch output control signal CLAT2, and can output image data DATA stored in the second latch unit 322 to the digital-to-analog converter 33.

The digital-to-analog converter 33 converts the image data DATA received from the latch unit 321 and 322 into a gamma voltage and generates data voltage Vdata.

The output buffers 341, 342, 343, 344, 345, and 346 can be provided in plural number. Each of the output buffers 341, 342, 343, 344, 345, and 346 can buffer and amplify data voltage Vdata output from the digital-to-analog converter 33, and output the voltage. An output terminal of each of the output buffers 341, 342, 343, 344, 345, and 346 can be connected to the buffer switching element BSW being turned on/off in response to a source output enable signal SOE.

The buffer switching element BSW is connected between the output buffers 341, 342, 343, 344, 345, and 346 and the data lines DL1, DL2, DL3, DL4, DL5, and DL6. The buffer switching element BSW can output the data voltage Vdata output from the output buffers 341, 342, 343, 344, 345, and 346 to the data line DL, for example, in response to the source output enable signal SOE.

In an embodiment, the source drive IC SDIC can further include a calculation unit 35 and a charge share circuit 36.

The charge share circuit 36 can include at least one charge share line CSL1, CSL2, and CSL3, and charge share switching elements SW11 to SW63 configured to control connections between the charge share lines CSL1, CSL2, and CSL3 and the data lines DL1, DL2, DL3, DL4, DL5, and DL6. The charge share circuit 36 can be embedded into the source drive IC SDIC or provided independently.

In FIG. 4, it is illustrated that three charge share lines CSL1, CSL2, and CSL3 are provided, however, the present embodiment is not limited thereto. The charge share circuit 36 can include a fewer or a greater quantity of charge share lines CSL1, CSL2, and CSL3.

In an embodiment, a quantity of the charge share lines CSL1, CSL2, and CSL3 can be determined based on a quantity of a grayscale region defined in the calculation unit 35 which will be described below. For example, the charge share circuit 36 can be configured to include the same or a fewer quantity of charge share lines CSL1, CSL2, and CSL3 than the quantity of a grayscale region defined in the calculation unit 35. However, the present embodiment is not limited thereto.

The charge share switching elements SW11 to SW63 can be turned on/off independently according to a control signal CS. The data lines DL1, DL2, DL3, DL4, DL5, and DL6 can be connected to one among the charge share lines CSL1, CSL2, and CSL3 corresponding thereto through the charge share switching elements SW11 to SW63 which are turned on.

The charge share switching elements SW11 to SW63 can be configured as a random circuit element for controlling electrical connections between the charge share lines CSL1, CSL2, and CSL3 and the data lines DL1, DL2, DL3, DL4, DL5, and DL6. For example, as illustrated in FIG. 5, the charge share switching element SW11 to SW63 can be configured as a transistor, but is not limited thereto. When the charge share switching element SW11 to SW63 is configured as a transistor, each of the charge share switching elements SW11 to SW63 is connected between the data lines DL1, DL2, DL3, DL4, DL5, and DL6 and the charge share lines CSL1, CSL2, and CSL3 corresponding thereto, and can be configured such that a gate electrode thereof is connected to the calculation unit 35 and receives a control signal CS.

The data lines DL1, DL2, DL3, DL4, DL5, and DL6 connected to one charge share line CSL1, CSL2, and CSL3 through the charge share switching element SW11 to SW63 can operate in the charge share mode. For example, the data lines DL1, DL2, DL3, DL4, DL5, and DL6 connected to one charge share line CSL1, CSL2, and CSL3 can share a voltage charged during a predetermined charge share period. Through the charge share, voltages of the data lines DL1, DL2, DL3, DL4, DL5, and DL6 charged to a relatively high voltage value can be applied to the data lines DL1, DL2, DL3, DL4, DL5, and DL6 charged to a relatively low voltage value. After the charge share, voltages of the data lines DL1, DL2, DL3, DL4, DL5, and DL6 connected to one charge share line CSL1, CSL2, and CSL3 can converge to an average value of voltages charged before the charge share (for example, an average value of voltages applied to the corresponding data lines).

After the charge share, the data lines DL1, DL2, DL3, DLA, DL5, and DL6 can quickly reach a required voltage. In particular, the data lines DL1, DL2, DL3, DL4, DL5, and DL6 which must be charged to a high voltage value in response to a high grayscale can be charged to a desired voltage value through the charge share in a short charging time. In addition, the data lines DL1, DL2, DL3, DL4, DL5, and DL6 are charged to a predetermined voltage value through the charge share, therefore, a voltage required for reaching a desired voltage value after the charge share is reduced. Through this configuration, power consumption of the source drive IC SDIC can be efficiently reduced.

The calculation unit 35 can generate a control signal CS based on a grayscale value of image data DATA output from the latch unit 321 and 322. The control signal CS can be, for example, a signal having a predetermined voltage or logic level for turning on or turning off the charge share switching element SW11 to SW63 of the charge share circuit 36.

In more detail, the calculation unit 35 can select at least one data line DL1, DL2, DL3, DL4, DL5, and DL6 subjected to fulfillment of the charge share based on a grayscale value of image data DATA output from the first latch unit 321. The calculation unit 35 can output the control signal CS to the charge share switching elements SW11 to SW63 so that the selected data lines DL1, DL2, DL3, DL4, DL5, and DL6 are connected to the same charge share line CSL1, CSL2, and CSL3.

In an embodiment, the calculation unit 35 can define a plurality of grayscale regions, and operate the data lines DL1, DL2, DL3, DL4, DL5, and DL6 to which image data DATA of the same grayscale region is to be output in the charge share mode. The plurality of grayscale regions can be defined to include one or more grayscale values between a smallest grayscale value and a greatest grayscale value, including the smallest grayscale value and the greatest grayscale value.

For example, the plurality of grayscale regions can include four grayscale regions, as illustrated in FIG. 6. Now, a first grayscale region A1 (a low grayscale region) includes Oth grayscale to 62nd grayscale, a second grayscale region A2 includes 63rd grayscale to 126th grayscale, a third grayscale region A3 includes 127th grayscale to 190th grayscale, and a fourth grayscale region A4 (a high grayscale region) includes 191st grayscale to 255th grayscale.

However, the grayscale region is not limited to what is illustrated in FIG. 6. In various other embodiments of the present disclosure, the grayscale regions can be defined to be provided in a fewer or a greater quantity than what is illustrated. Each of the grayscale regions can be configured to include the same or different quantity of grayscale values.

In an embodiment, the calculation unit 35 can determine into which grayscale region a grayscale value of image data DATA output from the first latch unit 321 is included. The calculation unit 35 can operate the data lines DL1, DL2, DL3, DL4, DL5, and DL6 to which image data DATA of the same grayscale region is applied in the charge share mode.

For example, the calculation unit 35 can control the charge share switching elements SW13 to SW63 to connect the data lines DL1, DL2, DL3, DL4, DL5, and DL6 to which image data DATA of the first grayscale region A1, illustrated in FIG. 6, is to be applied to the third charge share line CSL3. In addition, the calculation unit 35 can control the charge share switching elements SW11 to SW61 to connect the data lines DL1, DL2, DL3, DL4, DL5, and DL6 to which image data DATA of the second grayscale region A2 is to be applied to the first charge share line CSL1. Moreover, the calculation unit 35 can control the charge share switching elements SW12 to SW62 to connect the data lines DL1, DL2, DL3, DL4, DL5, and DL6 to which image data DATA of the third grayscale region A3 is to be applied to the second charge share line CSL2. Furthermore, the calculation unit 35 can control the charge share switching elements SW13 to SW63 to connect the data lines DL1, DL2, DL3, DL4, DL5, and DL6 to which image data DATA of the fourth grayscale region A4 is to be applied to the third charge share line CSL3. Here, the data lines DL1, DL2, DL3, DLA, DL5, and DL6 to which image data DATA of the high grayscale region (the fourth grayscale region A4) and the low grayscale region (the first grayscale region A1) is to be applied are connected to the same third charge share line CSL3. However, the embodiments of the present disclosure are not limited thereto.

In an embodiment, the calculation unit 35 can determine into which grayscale region a grayscale value of image data DATA continuously output from the first latch unit 321 is included, and determine whether to perform the charge share with respect to the next image data DATA based on a grayscale region of the previous image data DATA. Alternatively, the calculation unit 35 can determine whether to perform the charge share based on a change of the grayscale region of the image data DATA continuously output.

The method for controlling the charge share circuit 36 by the calculation unit 35 will be described in detail with reference to the drawings below.

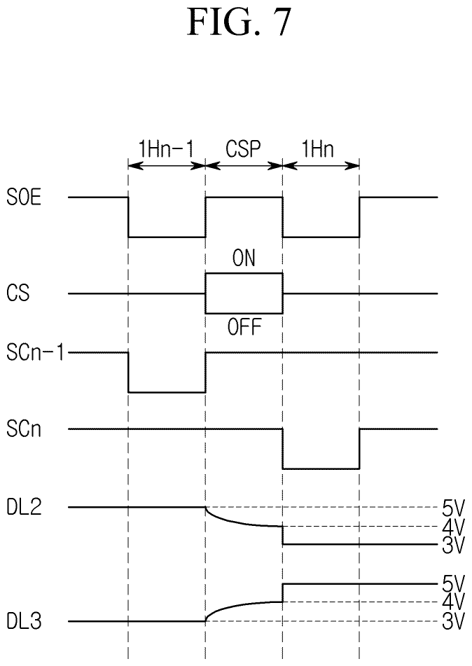

FIG. 7 is a waveform diagram illustrating signals applied to the pixel and the source drive IC according to embodiments of the present disclosure.

Referring to FIGS. 2, 4, and 7 together, the (n−1)th scan signal SCn−1 can be applied to the pixels PX disposed in a (n−1)th pixel row in a (n−1)th horizontal period 1Hn−1. In addition, the source output enable signal SOE in a turn-on level (for example, a low level) can be applied to the data drive IC SDIC. Then, the buffer switching element BWS can be turned on, and the data voltage Vdata output from the output buffers 341, 342, 343, 344, 345, and 346 can be applied to the pixels PX disposed in the (n−1)th pixel row. Then, each of the data lines DL1, DL2, DL3, DL4, DL5, and DL6 can be charged with the data voltage Vdata applied.

In the charge share period CSP, the source output enable signal SOE can switch over to a turn-off level (for example, a high level). Then, the buffer switching element BSW can be turned off, and the output buffers 341, 342, 343, 344, 345, and 346 can be electrically disconnected from the data lines DL1, DL2, DL3, DL4, DL5, and DL6.

In the charge share period CSP, the control signal CS can be applied to the charge share switching elements SW11 to SW63 through the calculation unit 35. At this instance, the control signal CS in a turn-on level can be applied to the charge share switching elements SW11 to SW63 connected to the data lines DL1, DL2, DL3, DL4, DL5, and DL6 subjected to operate in the charge share mode. Reversely, the control signal CS in a turn-off level can be applied to the charge share switching elements SW11 to SW63 connected to the data lines DL1, DL2, DL3, DL4, DL5, and DL6 subjected not to operate in the charge share mode.

In the charge share period CSP, the voltage can be distributed between the data lines DL1, DL2, DL3, DL4, DL5, and DL6 connected to one charge share line CSL1, CSL2, and CSL3. That is, the voltage can be redistributed from the data lines DL1, DL2, DL3, DLA, DL5, and DL6 charged to a high data voltage Vdata in the (n−1)th horizontal period 1Hn−1 to the data lines DL1, DL2, DL3, DL4, DL5, and DL6 charged to a low data voltage Vdata. After the charge share period CSP, voltages of the data lines DL1, DL2, DL3, DL4, DL5, and DL6 connected to one charge share line CSL1, CSL2, and CSL3 can converge to an average value of voltages charged before the charge share.

In FIG. 7, for example, a case in which the second and third data lines DL2 and DL3 are charge-shared is illustrated. In the (n−1)th horizontal period 1Hn−1, the second data line DL2 charged to 5V and the third data line DL3 charged to 3V can be charged to 4V, which is an average voltage value, after the charge share.

In the n-th horizontal period 1Hn, the n-th scan signal SCn can be applied to the pixels PX disposed in the n-th pixel row. In addition, the source output enable signal SOE in a turn-on level (for example, a low level) can be applied to the data drive IC. Then, the buffer switching element BSW can be turned on, and the data voltage Vdata output from the output buffers 341, 342, 343, 344, 345, and 346 can be applied to the pixels PX disposed in the n-th pixel row. Then, each of the data lines DL1, DL2, DL3, DL4, DL5, and DL6 can be charged with the data voltage Vdata applied.

To allow the data lines DL1, DL2, DL3, DL4, DL5, and DL6 to be charged to a voltage corresponding to the required image data DATA, a data voltage Vdata corresponding to a difference between the voltage charged before, for example, the redistributed voltage and the required charge voltage can be applied to each of the data lines DL1, DL2, DL3, DL4, DL5, and DL6. At this instance, when the difference between the voltage charged before and the required charge voltage is great, a magnitude of a difference voltage to be applied to the data lines DL1, DL2, DL3, DL4, DL5, and DL6 increases, and thus, the power consumption of the source drive IC SDIC can increase. Reversely, when the difference between the voltage charged before and the required charge voltage is small, a magnitude of a difference voltage to be applied to the data lines DL1, DL2, DL3, DL4, DL5, and DL6 decreases, and thus, the power consumption of the source drive IC SDIC can decrease.

For example, when the charge share mode is not applied, if the charge voltage required for the third data line DL3 in the n-th horizontal period 1Hn is 5V, a voltage rise by 2V is required in the third data line DL3. However, when the charge share mode is applied, the voltage rise by only IV can make the third data line DL3 reach the required charge voltage, therefore, the power consumption of the source drive IC SDIC is reduced.

By using the charge share mode provided in the above-described manner, a voltage output to the data lines DL1, DL2, DL3, DL4, DL5, and DL6 can reach a target data voltage quickly, thereby the image quality deterioration can be improved and the image quality can be improved.

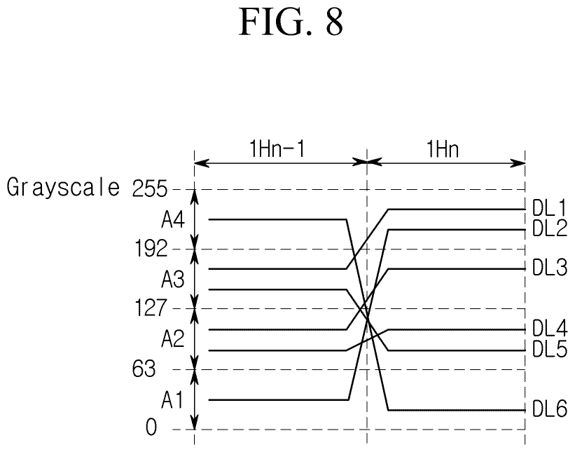

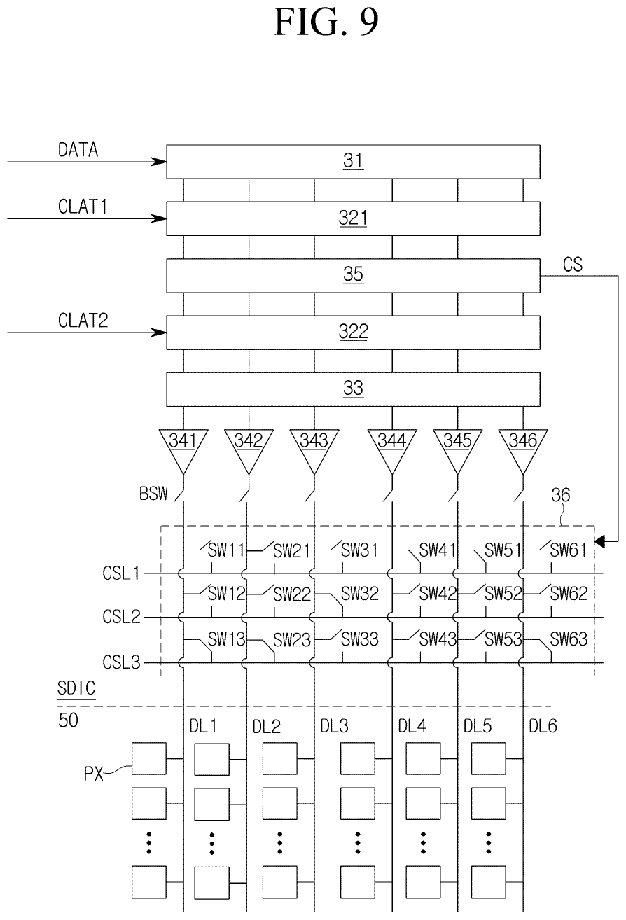

FIG. 8 is a diagram illustrating an example of changes of grayscale values of data voltages between the horizontal periods. FIG. 9 is a diagram illustrating an example of an operating state of the charge share circuit according to embodiments in FIG. 8.

In the embodiment in FIGS. 8 and 9, referring to FIG. 4 as well, the calculation unit 35 can determine into which grayscale region a grayscale value of image data DATA output from the first latch unit 321 is included, and can control the charge share switching elements SW11 to SW63 to connect the data lines DL1, DL2, DL3, DL4, DL5, and DL6 to which image data DATA of the same grayscale region is to be applied to the same charge share line CSL1, CSL2, and CSL3.

In more detail, in the embodiment in FIG. 8, the calculation unit 35 can determine into which grayscale region a grayscale value of image data DATA output from the first latch unit 321 is included, in correspondence with the n-th horizontal period 1Hn. The calculation unit 35 can operate the data lines DL1, DL2, DL3, DL4, DL5, and DL6 to which image data DATA of the same grayscale region is to be applied in the charge share mode.

Referring to FIG. 9, the calculation unit 35 can output a control signal CS to turn on the 63rd charge share switching element SW63 so that the sixth data line DL6 to which image data DATA of the first grayscale region A1 is to be applied can be connected to the third charge share line CSL3. The calculation unit 35 can output a control signal CS to turn on the 41st and 51st charge share switching elements SW41 and SW51 so that the fourth and fifth data lines DLA and DL5 to which image data DATA of the second grayscale region A2 is to be applied can be connected to the first charge share line CSL1. The calculation unit 35 can output a control signal CS to turn on the 32nd charge share switching element SW32 so that the third data line DL3 to which image data DATA of the third grayscale region A3 is to be applied can be connected to the second charge share line CSL2. In addition, the calculation unit 35 can output a control signal CS to turn on the 13th and 23rd charge share switching elements SW13 and SW23 so that the first and second data lines DL1 and DL2 to which image data DATA of the fourth grayscale region A4 is to be applied can be connected to the third charge share line CSL3.

The fourth and fifth data lines DL4 and DL5 connected to the first charge share line CSL1 in response to the control signal CS can be charged by sharing the voltage charged in the previous period. In addition, the third data line DL3 connected to the second charge share line CSL2 can be charged by sharing the voltage charged in the previous period with the data lines connected. In addition, the first, second and sixth data lines DL1, DL2, and DL6 connected to the third charge share line CSL3 can be charged by sharing the voltage charged in the previous period.

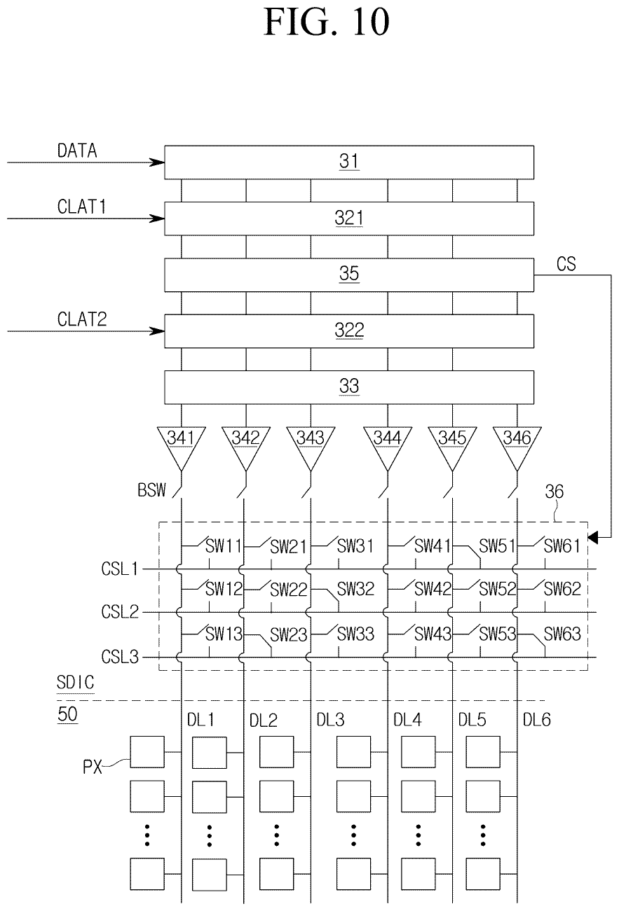

FIG. 10 is a diagram illustrating another example of an operating state of a charge share circuit according to embodiments in FIG. 8.

In the embodiment in FIGS. 8 and 10, referring to FIG. 4 together, the calculation unit 35 can determine into which grayscale region a grayscale value of image data DATA output from the first latch unit 321 is included, and can control the charge share switching elements SW11 to SW63 to connect the data lines DL1, DL2, DL3, DL4, DL5, and DL6, to which image data DATA included in the same grayscale region is to be applied, to the same charge share line CSL1, CSL2, and CSL3.

At this instance, the calculation unit 35 can determine into which grayscale region a grayscale value of image data DATA continuously output from the first latch unit 321 is included, and determine whether to perform the charge share with respect to the next image data DATA based on a grayscale region of the previous image data DATA. Alternatively, the calculation unit 35 can determine whether to perform the charge share based on a change of the grayscale region of the image data DATA continuously output.

In more detail, in the embodiment in FIG. 8, the calculation unit 35 can determine into which grayscale region (hereinafter, a previous grayscale region) a grayscale value of image data DATA continuously output from the first latch unit 321 is included, in correspondence with an (n−1)th (n is a natural number) horizontal period 1Hn−1. In addition, the calculation unit 35 can determine into which grayscale region (hereinafter, a next grayscale region) a grayscale value of image data DATA continuously output from the first latch unit 321 is included, in correspondence with an n-th horizontal period 1Hn.

In an embodiment, when the previous grayscale region and the next grayscale region are the same, the calculation unit 35 may not apply the charge share mode with respect to the data lines DL1, DL2, DL3, DL4, DL5, and DL6 to which the corresponding image data DATA is to be applied. In an illustrated embodiment, in the (n−1)th horizontal period 1Hn−1, image data DATA of the second grayscale region A2 is output to the fourth data line DL4, and in the n-th horizontal period 1Hn, image data DATA of the second grayscale region A2 is output to the fourth data line DLA. In such an embodiment, the calculation unit 35 can output a control signal CS to turn off the charge share switching elements SW41, SW42, and SW43 connected to the fourth data line DL4 so that the fourth data line DL4 does not operate in the charge share mode.

In an embodiment, the calculation unit 35 can apply the charge share mode with respect to the data lines DL1, DL2, DL3, DL4, DL5, and DL6 to which the corresponding image data DATA is to be applied when the previous grayscale region and the next grayscale region correspond to a predetermined condition.

For example, the calculation unit 35 can apply the charge share mode with respect to the data lines DL1, DL2, DL3, DL4, DL5, and DL6 to which the corresponding image data DATA is to be applied when the next grayscale region is the fourth grayscale region A4 and the previous grayscale region is the first grayscale region A1. In an illustrated embodiment, in the (n−1)th horizontal period 1Hn−1, image data DATA of the third grayscale region A3 can be output to the first data line DL1, and in the n-th horizontal period 1Hn, image data DATA of the fourth grayscale region A4 can be output to the first data line DL1. The next grayscale region of the image data DATA to be applied to the first data line DL1 is the fourth grayscale region A4, however, the previous grayscale region is not the first grayscale region A1, therefore, the calculation unit 35 can output a control signal to turn off the 13th charge share switching element SW13.

In an illustrated embodiment, in the (n−1)th horizontal period 1Hn−1, image data DATA of the first grayscale region A1 can be output to the second data line DL2, and in the n-th horizontal period 1Hn, image data DATA of the fourth grayscale region A4 can be output to the second data line DL2. The next grayscale region of the image data DATA to be applied to the second data line DL2 is the fourth grayscale region A4, and the previous grayscale region thereof is the first grayscale region A1, therefore, the calculation unit 35 can output a control signal CS to turn on the 23rd charge share switching element SW23.

For example, when the next grayscale region is the first grayscale region A1 and the previous grayscale region is the fourth grayscale region A4, the calculation unit 35 can apply the charge share mode with respect to the data lines DL1, DL2, DL3, DL4, DL5, and DL6 to which the corresponding image data DATA is to be applied. In an illustrated embodiment, in the (n−1)th horizontal period 1Hn−1, image data DATA of the fourth grayscale region A4 can be output to the sixth data line DL6, and in the n-th horizontal period 1Hn, image data DATA of the first grayscale region A1 can be output to the sixth data line DL6. The next grayscale region of the image data DATA to be applied to the sixth data line DL6 is the first grayscale region A1, and the previous grayscale region thereof is the fourth grayscale region A4, therefore, the calculation unit 35 can output a control signal CS to turn on the 63rd charge share switching element SW63.

Based on the predetermined condition as described above, the calculation unit 35 can operate the data lines DL1, DL2, DL3, DL4, DL5, and DL6 to which image data DATA of the same grayscale region is to be applied in the charge share mode. In more detail, the calculation unit 35 can operate, in the charge share mode, the data lines DL2 and DL6 which satisfy the above-described condition among the data lines DL1, DL2, and DL6 to which image data DATA of the first and fourth grayscale regions A1 and A4 is to be applied so that the data lines DL2 and DL6 are connected to one charge share line CSL3. In addition, the calculation unit 35 can operate, in the charge share mode, the data line DL3 which satisfies the above-described condition among the data line DL3 to which image data DATA of the third grayscale region A3 is to be applied so that the data line DL3 is connected to one charge share line CSL2. In addition, the calculation unit 35 can operate, in the charge share mode, the data line DL5 which satisfies the above-described condition among the data lines DL4 and DL5 to which image data DATA of the second grayscale region A2 is to be applied so that the data line DL5 is connected to one charge share line CSL1.

Referring to FIG. 10, the calculation unit 35 can output a control signal CS to turn on the 23rd charge share switching element SW23 and the 63rd charge share switching element SW63 so that the sixth data line DL6 and the second data line DL2 to which image data DATA of the first grayscale region A1 and the fourth grayscale region A4 is to be applied can be connected to the third charge share line CSL3.

The calculation unit 35 can output a control signal CS to turn on the 51st charge share switching element SW51 so that the fifth data line DL5 to which image data DATA of the second grayscale region A2 is to be applied can be connected to the first charge share line CSL1.

The calculation unit 35 can output a control signal CS to turn on the 32nd charge share switching element SW32 so that the third data line DL3 to which image data DATA of the third grayscale region A3 is to be applied can be connected to the second charge share line CSL2.

In addition, the calculation unit 35 can output a control signal CS to turn on the 23rd charge share switching element SW23 so that the second data line DL2 to which image data DATA of the fourth grayscale region A4 is to be applied can be connected to the third charge share line CSL3. The third data line DL3 can perform charge share with a data line to which image data DATA of the third gray scale region A3 is to be applied.

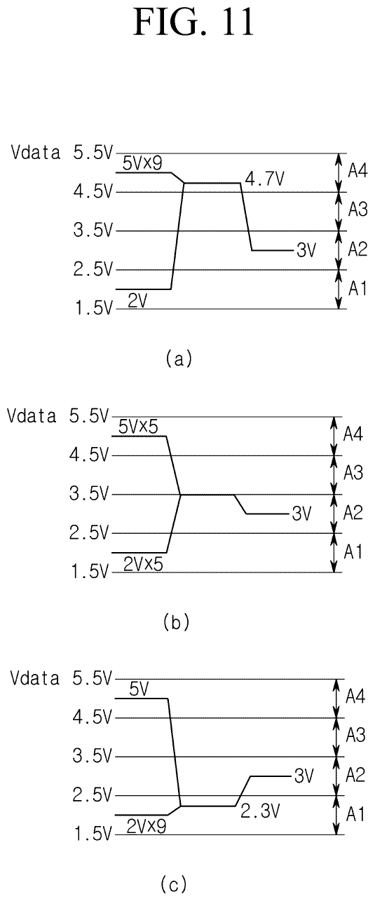

FIGS. 11 to 14 are diagrams illustrating an effect of improving power consumption according to the charge share operation.

First, FIG. 11 shows an effect of improving power consumption when operating the data lines to which image data DATA corresponding to the second grayscale region A2 in the charge share mode.

Referring to (a) of FIG. 11, in the (n−1)th horizontal period 1Hn−1, a data voltage Vdata corresponding to image data DATA of the fourth grayscale region A4 can be charged to nine data lines, and a data voltage Vdata corresponding to image data DATA of the first grayscale region A1 can be charged to one data line. In an embodiment, the data voltage Vdata included in the fourth grayscale region A4 can be 5V, and the data voltage Vdata included in the first grayscale region A1 can be 2V.

When the charged voltage is divided among the data lines through the charge share, an average value of the already charged voltage, for example, (5*9+2)/10=4.7V is charged to each of the data lines.

In the n-th horizontal period 1Hn, the data lines can be charged to the data voltage Vdata corresponding to image data DATA of the second grayscale region A2. In an embodiment, the data voltage Vdata corresponding to the second grayscale region A2 can be 3V.

When the charge share is not performed, in the n-th horizontal period 1Hn, a voltage of 1V must be further applied to the data line which has been charged to the data voltage Vdata corresponding to the first grayscale region A1. However, as the charge share is performed, and a voltage of 4.7V is charged in advance to the corresponding data line, the corresponding data line can require to be discharged to 3V in the n-th horizontal period 1Hn. Likewise, other data lines can require to be discharged to 3V. Therefore, the power consumption of the source drive IC SDIC can decrease by as much as about 1V.

Referring to (b) of FIG. 11, in the (n−1)th horizontal period 1Hn−1, a data voltage Vdata of 5V corresponding to image data DATA of the fourth grayscale region A4 can be charged to five data lines, and a data voltage Vdata of 2V corresponding to image data DATA of the first grayscale region A1 can be charged to five data lines.

When the charged voltage is divided among the data lines through the charge share, an average value of the already charged voltage, for example, (5*5+2*5)/10=3.5V is charged to each of the data lines.

In the n-th horizontal period 1Hn, the data lines can be charged to the data voltage Vdata corresponding to image data DATA of the second grayscale region A2. When the charge share is not performed, in the n-th horizontal period 1Hn, a voltage of 1V must be further applied to the data lines which have been charged to the data voltage Vdata corresponding to the first grayscale region A1, and in total, a data voltage Vdata of 5V must be applied to five data lines.

However, as the charge share is performed, and a voltage of 3.5V is charged in advance to the corresponding data line, the corresponding data line can require to be discharged to 3V in the n-th horizontal period 1Hn. Therefore, the power consumption of the source drive IC SDIC can decrease by as much as about 5V.

Referring to (c) of FIG. 11, in the (n−1)th horizontal period 1Hn−1, a data voltage Vdata corresponding to image data DATA of the fourth grayscale region A4 can be charged to one data line, and a data voltage Vdata corresponding to image data DATA of the first grayscale region A1 can be charged to nine data lines.

When the charged voltage is divided among the data lines through the charge share, an average value of the already charged voltage, for example, (5+2*9)/10=2.3V is charged to each of the data lines.

In the n-th horizontal period 1Hn, the data lines can be charged to the data voltage Vdata corresponding to image data DATA of the second grayscale region A2. When the charge share is not performed, in the n-th horizontal period 1Hn, a voltage of 1V must be further applied to the data lines which have been charged to the data voltage Vdata corresponding to the first grayscale region A1, and in total, a data voltage Vdata of 9V must be applied to nine data lines. The data lines which have been charged to the data voltage Vdata corresponding to the fourth grayscale region A4 require to be discharged to 3V.

As the charge share is performed, and a voltage of 2.3V is charged in advance to the corresponding data line, in the n-th horizontal period 1Hn, a data voltage Vdata of 0.7V must be applied to the corresponding data lines, and a voltage of 7V is required for the whole data lines.

As a result, when the charge share is performed, the power consumption of the source drive IC SDIC can be reduced by as much as about 2V.

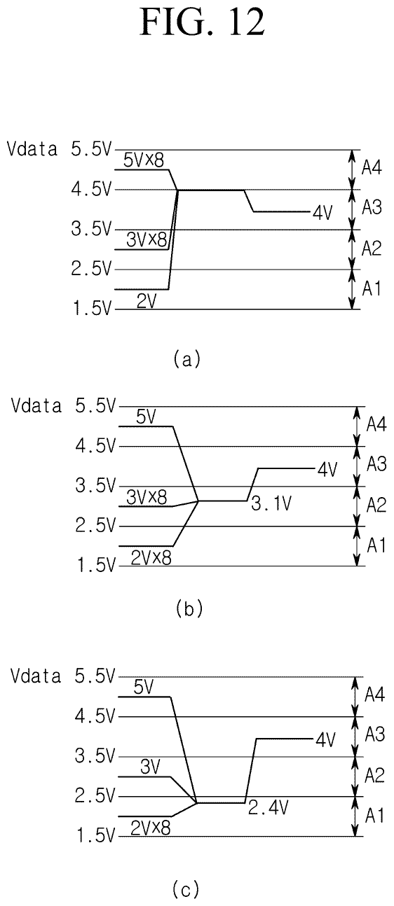

FIG. 12 shows an effect of improving power consumption when operating the data lines to which the image data DATA corresponding to the third grayscale region A3 is to be applied in the charge share mode.

Referring to (a) of FIG. 12, in the (n−1)th horizontal period 1Hn−1, a data voltage Vdata corresponding to image data DATA of the fourth grayscale region A4 can be charged to eight data lines, a data voltage Vdata corresponding to image data DATA of the second grayscale region A2 can be charged to one data line, and a data voltage Vdata corresponding to image data DATA of the first grayscale region A1 can be charged to one data line. In an embodiment, the data voltage Vdata corresponding to the fourth grayscale region A4 can be 5V, the data voltage Vdata corresponding to the second grayscale region A2 can be 3V, and the data voltage Vdata corresponding to the first grayscale region A1 can be 2V.

When the charged voltage is divided among the data lines through the charge share, an average value of the already charged voltage, for example, (5*8+3+2)/10=4.5V is charged to each of the data lines.

In the n-th horizontal period 1Hn, the data lines can be charged to the data voltage Vdata corresponding to image data DATA of the third grayscale region A3. In an embodiment, the data voltage Vdata corresponding to the third grayscale region A3 can be 4V.

When the charge share is not performed, in the n-th horizontal period 1Hn, a voltage of 1V must be further applied to the data line which has been charged to the data voltage Vdata corresponding to the second grayscale region A2, and a voltage of 2V must be further applied to the data line which has been charged to the data voltage Vdata corresponding to the first grayscale region A1. The data line which has been charged to the data voltage Vdata corresponding to the fourth grayscale region A4 can require to be discharged to 4V.

As the charge share is performed, and a voltage of 4.5V is charged in advance to the corresponding data line, the corresponding data lines can require to be discharged to 4V in the n-th horizontal period 1Hn. Therefore, the power consumption of the source drive IC SDIC can decrease by as much as about 3V.

Referring to (b) of FIG. 12, in the (n−1)th horizontal period 1Hn−1, a data voltage Vdata corresponding to image data DATA of the fourth grayscale region A4 can be charged to one data line, a data voltage Vdata corresponding to image data DATA of the second grayscale region A2 can be charged to eight data lines, and a data voltage Vdata corresponding to image data DATA of the first grayscale region A1 can be charged to one data line.

When the charged voltage is divided among the data lines through the charge share, an average value of the already charged voltage, for example, (5+3*8+2)/10=3.1V is charged to each of the data lines.

In the n-th horizontal period 1Hn, the data lines can be charged to the data voltage Vdata corresponding to image data DATA of the third grayscale region A3. When the charge share is not performed, in the n-th horizontal period 1Hn, a voltage of IV must be further applied to the data line which has been charged to the data voltage Vdata corresponding to the second grayscale region A2, and in total, a data voltage Vdata of 8V must be applied to eight data lines. In addition, 2V must be further applied to the data line which has been charged to the data voltage Vdata corresponding to the first grayscale region A1. The data line which has been charged to the data voltage Vdata corresponding to the fourth grayscale region A4 can require to be discharged to 4V. For example, in total, a voltage of 10V must be applied to the whole data lines.

As the charge share is performed, and a voltage of 3.1V is charged in advance to the corresponding data line, in the n-th horizontal period 1Hn, a data voltage Vdata of 0.9V must be applied to the corresponding data lines, and a voltage of 9V is required for the whole data lines.

As a result, when the charge share is performed, the power consumption of the source drive IC SDIC can be reduced by as much as about 1V.

Referring to (c) of FIG. 12, in the (n−1)th horizontal period 1Hn−1, a data voltage Vdata corresponding to image data DATA of the fourth grayscale region A4 can be charged to one data line, a data voltage Vdata corresponding to image data DATA of the second grayscale region A2 can be charged to one data line, and a data voltage Vdata corresponding to image data DATA of the first grayscale region A1 can be charged to eight data lines.

When the charged voltage is divided among the data lines through the charge share, an average value of the already charged voltage, for example, (5+3+2*8)/10=2.4V is charged to each of the data lines.

In the n-th horizontal period 1Hn, the data lines can be charged to the data voltage Vdata corresponding to image data DATA of the third grayscale region A3. When the charge share is not performed, in the n-th horizontal period 1Hn, a voltage of 1V must be further applied to the data line which has been charged to the data voltage Vdata corresponding to the second grayscale region A2. In addition, a voltage of 2V must be further applied to the data line which has been charged to the data voltage Vdata corresponding to the first grayscale region A1, and a voltage of 16V must be applied to eight data lines. The data line which has been charged to the data voltage Vdata corresponding to the fourth grayscale region A4 can require to be discharged to 4V. For example, in total, a voltage of 17V must be applied to the whole data lines.

As the charge share is performed, and a voltage of 2.4V is charged in advance to the corresponding data line, in the n-th horizontal period 1Hn, a data voltage Vdata of 1.6V must be applied to the corresponding data lines, and a voltage of 16V is required for the whole data lines.

As a result, when the charge share is performed, the power consumption of the source drive IC SDIC can be reduced by as much as about 1V.

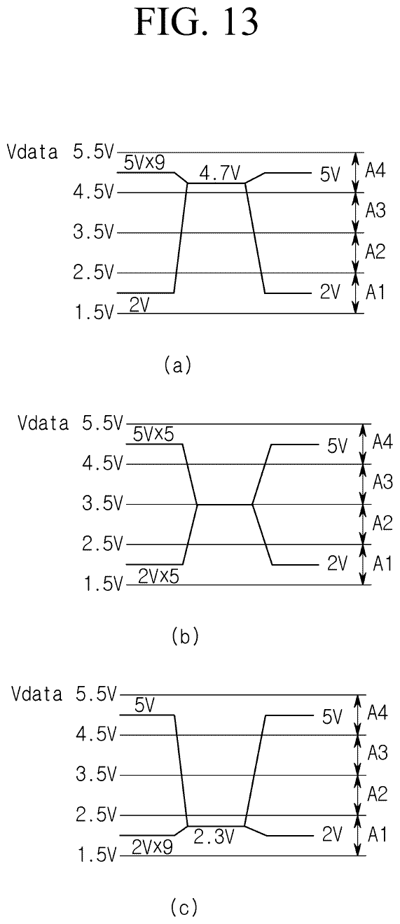

FIG. 13 shows an effect of improving power consumption when operating, in the charge share mode, the data lines to which image data DATA corresponding to the first grayscale region A1 and the fourth grayscale region A4 is to be output.

Referring to (a) of FIG. 13, in the (n−1)th horizontal period 1Hn−1, a data voltage Vdata corresponding to image data DATA of the fourth grayscale region A4 can be charged to nine data lines, and a data voltage Vdata corresponding to image data DATA of the first grayscale region A1 can be charged to one data line. In an embodiment, the data voltage Vdata corresponding to the fourth grayscale region A4 can be 5V, and the data voltage Vdata corresponding to the first grayscale region A1 can be 2V.

When the charged voltage is divided among the data lines through the charge share, an average value of the already charged voltage, for example, (5*9+2)/10=4.7V is charged to each of the data lines.

In the n-th horizontal period 1Hn, a data voltage Vdata corresponding to image data DATA of the first grayscale region A1 can be charged to nine data lines, and a data voltage Vdata corresponding to image data DATA of the fourth grayscale region A4 can be charged to one data line.

When the charge share is not performed, in the n-th horizontal period 1Hn, a voltage of 3V must be further applied to the data line which has been charged to the data voltage Vdata corresponding to the first grayscale region A1. The data line which has been charged to the data voltage Vdata corresponding to the fourth grayscale region A4 can require to be discharged to 2V.

As the charge share is performed, and a voltage of 4.7V is charged in advance to the corresponding data line, in the n-th horizontal period 1Hn, a data voltage Vdata of 0.3V must be further applied to data line which was previously charged to the data voltage Vdata corresponding to the first grayscale region A1.

As a result, when the charge share is performed, the power consumption of the source drive IC SDIC can be reduced by as much as about 2.7V.

Referring to (b) of FIG. 13, in the (n−1)th horizontal period 1Hn−1, a data voltage Vdata corresponding to image data DATA of the fourth grayscale region A4 can be charged to five data lines, and a data voltage Vdata corresponding to image data DATA of the first grayscale region A1 can be charged to five data lines.

When the charged voltage is divided among the data lines through the charge share, an average value of the already charged voltage, for example, (5*5+2*5)/10=3.5V is charged to each of the data lines.

In the n-th horizontal period 1Hn, a data voltage Vdata corresponding to image data DATA of the first grayscale region A1 can be charged to five data lines, and a data voltage Vdata corresponding to image data DATA of the fourth grayscale region A4 can be charged to five data lines.

When the charge share is not performed, in the n-th horizontal period 1Hn, a voltage of 3V must be further applied to the data line which has been charged to the data voltage Vdata corresponding to the first grayscale region A1, and a voltage of 15V must be further applied to five data lines. The data line which has been charged to the data voltage Vdata corresponding to the fourth grayscale region A4 can require to be discharged to 2V.

As the charge share is performed, and a voltage of 3.5V is charged in advance to the corresponding data line, in the n-th horizontal period 1Hn, a data voltage Vdata of 1.5V must be further applied to the data line which was previously charged to the data voltage Vdata corresponding to the first grayscale region A1, and a voltage of 7.5V must be further applied to five data lines.

As a result, when the charge share is performed, the power consumption of the source drive IC SDIC can be reduced by as much as about 7.5V.

Referring to (c) of FIG. 13, in the (n−1)th horizontal period 1Hn−1, a data voltage Vdata corresponding to image data DATA of the fourth grayscale region A4 can be charged to one data line, and a data voltage Vdata corresponding to image data DATA of the first grayscale region A1 can be charged to nine data lines.

When the charged voltage is divided among the data lines through the charge share, an average value of the already charged voltage, for example, (5+2*9)/10=2.3V is charged to each of the data lines.

In the n-th horizontal period 1Hn, a data voltage Vdata corresponding to image data DATA of the first grayscale region A1 can be charged to one data line, and a data voltage Vdata corresponding to image data DATA of the fourth grayscale region A4 can be charged to nine data lines.

When the charge share is not performed, in the n-th horizontal period 1Hn, a voltage of 3V must be further applied to the data line which has been charged to the data voltage Vdata corresponding to the first grayscale region A1, and a voltage of 27V must be further applied to nine data lines. The data line which has been charged to the data voltage Vdata corresponding to the fourth grayscale region A4 can require to be discharged to 2V.

As the charge share is performed, and a voltage of 2.3V is charged in advance to the corresponding data line, in the n-th horizontal period 1Hn, a data voltage Vdata of 2.7V must be further applied to the data line which was previously charged to the data voltage Vdata corresponding to the first grayscale region A1, and a voltage of 24.3V must be further applied to nine data lines.

As a result, when the charge share is performed, the power consumption of the source drive IC SDIC can be reduced by as much as about 2.7V.

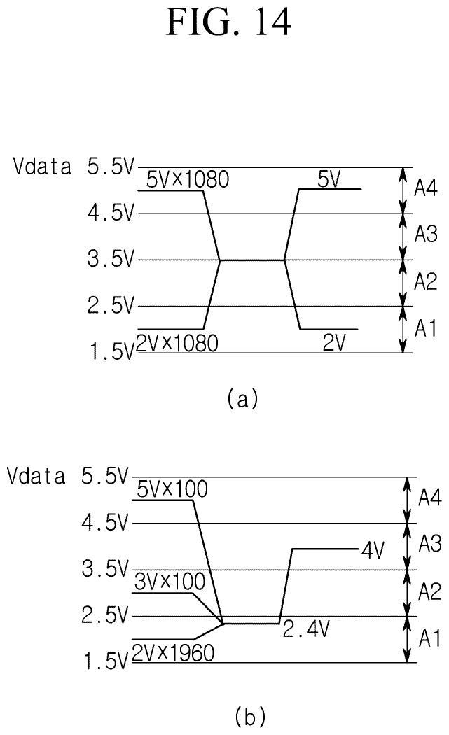

FIG. 14 shows an effect of improving power consumption when operating the data lines connected to 2,160 output buffer channels in the charge share mode.

Referring to (a) of FIG. 14, in the (n−1)th horizontal period 1Hn−1, a data voltage Vdata corresponding to image data DATA of the fourth grayscale region A4 can be charged to 1,080 data lines, and a data voltage Vdata corresponding to image data DATA of the first grayscale region A1 can be charged to the remaining other 1,080 data lines. In an embodiment, the data voltage Vdata corresponding to the fourth grayscale region A4 can be 5V, and the data voltage Vdata corresponding to the first grayscale region A1 can be 2V.

When the charged voltage is divided among the data lines through the charge share, an average value of the already charged voltage, for example, (5*1080+2*1080)/2160=3.5V is charged to each of the data lines.

In the n-th horizontal period 1Hn, a data voltage Vdata corresponding to image data DATA of the first grayscale region A1 can be charged to 1,080 data lines, and a data voltage Vdata corresponding to image data DATA of the fourth grayscale region A4 can be charged to the remaining other 1,080 data lines.

When the charge share is not performed, in the n-th horizontal period 1Hn, a voltage of 3V must be further applied to the data line which has been charged to the data voltage Vdata corresponding to the first grayscale region A1, and a voltage of 3,240V must be applied to, in total, 1,080 data lines. When the capacitance of the data lines is 32 pF, and during 4.5 us which is the one horizontal period, the data voltage is time-dividedly output through 1,080 channels, the amount of the current applied to the data lines is 23.04 mA. The data line which has been charged to the data voltage Vdata corresponding to the fourth grayscale region A4 can require discharging only.

As the charge share is performed, and a voltage of 3.5V is charged in advance to the data lines, in the n-th horizontal period 1Hn, a data voltage Vdata of 1.5V must be further applied to the data line which was previously charged to the data voltage Vdata corresponding to the first grayscale region A1, and a voltage of 1,620V must be applied to, in total, 1,080 data lines. When the capacitance of the data lines is 32 pF, and the one horizontal period is 4.5 us, the amount of the current applied to the data lines is 11.52 mA.

When six source drive ICs SDIC are provided in the data driver 30, the power consumption which is reduced through the fulfillment of the charge share in the entire source drive IC SDIC can be 69.12 mW.

Referring to (b) of FIG. 14, in the (n−1)th horizontal period 1Hn−1, a data voltage Vdata corresponding to image data DATA of the fourth grayscale region A4 can be charged to 100 data lines, a data voltage Vdata corresponding to image data DATA of the second grayscale region A2 can be charged to the other 100 data lines, and a data voltage Vdata corresponding to image data DATA of the first grayscale region A1 can be charged to the remaining 1,960 data lines. In an embodiment, the data voltage Vdata corresponding to the fourth grayscale region A4 can be 5V, the data voltage Vdata corresponding to the second grayscale region A2 can be 3V, and the data voltage Vdata corresponding to the first grayscale region A1 can be 2V.

When the charged voltage is divided among the data lines through the charge share, an average value of the already charged voltage, for example, (5*100+3*100+2*1960)/2160-2.2V is charged to each of the data lines.

In the n-th horizontal period 1Hn, a data voltage Vdata corresponding to image data DATA of the third grayscale region A3 can be charged to data lines. In an embodiment, the data voltage Vdata corresponding to the third grayscale region A3 may be 4V.

When the charge share is not performed, in the n-th horizontal period 1Hn, a voltage of 1V must be further applied to the data line which has been charged to the data voltage Vdata corresponding to the second grayscale region A2, and a voltage of 100V must be applied to, in total, 100 data lines. In addition, a voltage of 2V must be further applied to the data line which has been charged to the data voltage Vdata corresponding to the first grayscale region A1, and a voltage of 3,920V must be further applied to, in total, 1,960 data lines. As a result, a voltage of 4,020V must be applied to the whole data lines.

When the capacitance of the data lines is 32 pF, and during 4.5 us which is the one horizontal period, the data voltage is time-dividedly output through 1,080 channels, the amount of the current applied to the data lines is 14.65 mA if such a pattern is repeated in two horizontal periods. The data line which has been charged to the data voltage Vdata corresponding to the fourth grayscale region A4 can require discharging only.

As the charge share is performed, and a voltage of 2.2V is charged in advance to the corresponding data line, in the n-th horizontal period 1Hn, a data voltage Vdata of 1.8V must be applied to the corresponding data lines, and a voltage of 3,888V must be applied to, in total, 2,160 data lines. When the capacitance of the data lines is 32 pF, and the one horizontal period is 4.5 us, the amount of the current applied to the data lines is 14.18 mA if such a pattern is repeated in two horizontal periods.

When six source drive ICs SDIC are provided in the data driver 30, the power consumption which is reduced through the fulfillment of the charge share in the entire source drive IC SDIC can be 2.82 mW.

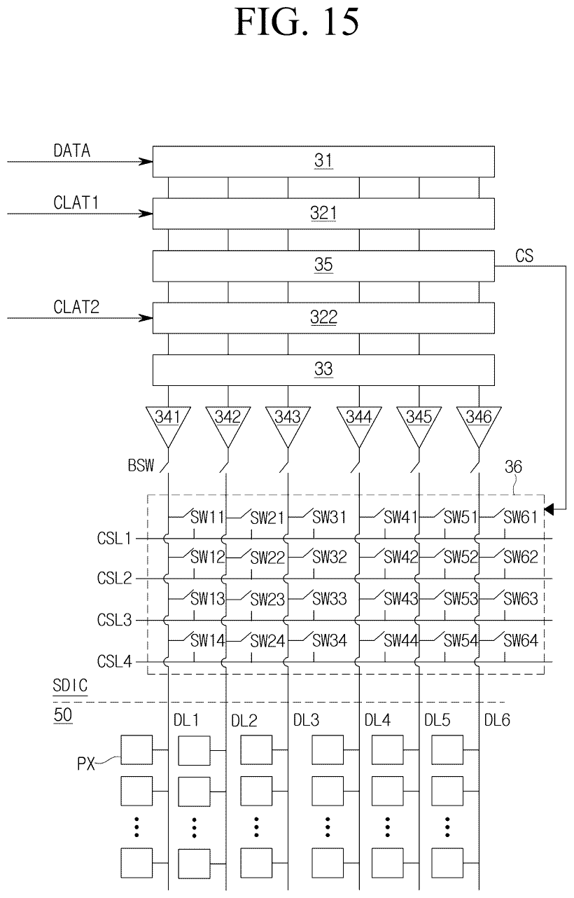

FIG. 15 is a block diagram illustrating a configuration of a source drive IC according to a third embodiment of the present disclosure. The embodiment in FIG. 15 is substantially the same as the embodiment in FIG. 4 except that four charge share lines CSL1, CSL2, CSL3, and CSL4 are provided, therefore, like reference numerals are provided to like elements, and detailed description thereof will be omitted or may be briefly provided.

Referring to FIG. 15, the source drive IC SDIC can include the register unit 31, the latch units 321 and 322, the digital-to-analog converter 33, the one or more output buffers 341, 342, 343, 344, 345, and 346, and the buffer switching element BSW. The source drive IC SDIC can further include the calculation unit 35 and a charge share circuit 36′.

The charge share circuit 36 can include at least one charge share line CSL1, CSL2, CSL3, and CSL4 and charge share switching elements SW11 to SW64 configured to control connections between the charge share lines CSL1, CSL2, CSL3, and CSL4 and the data lines DL1, DL2, DL3, DL4, DL5, and DL6. The charge share circuit 36 can be embedded into the source drive IC SDIC or provided independently.

In FIG. 15, it is illustrated that four charge share lines CSL1, CSL2, CSL3, and CSLA are provided, however, the embodiments of the present disclosure are not limited thereto. The charge share circuit 36 can include a fewer or a greater quantity of charge share lines CSL1, CSL2, CSL3, and CSL4.

In an embodiment, a quantity of the charge share lines CSL1, CSL2, CSL3, and CSLA can be determined based on a quantity of a grayscale region defined in the calculation unit 35 which will be described below. For example, the charge share circuit 36 can be configured to include the same or a fewer quantity of charge share lines CSL1, CSL2, CSL3, and CSL4 than the quantity of a grayscale region defined in the calculation unit 35. However, the present embodiment is not limited thereto.

The charge share switching elements SW11 to SW64 can be turned on/off independently according to a control signal CS. The data lines DL1, DL2, DL3, DLA, DL5, and DL6 can be connected to one among the charge share lines CSL1, CSL2, CSL3, and CSL4 corresponding thereto through the charge share switching elements SW11 to SW64 which are turned on.

The data lines DL1, DL2, DL3, DL4, DL5, and DL6 connected to one charge share line CSL1, CSL2, CSL3, and CSL4 through the charge share switching element SW11 to SW64 can operate in the charge share mode. For example, the data lines DL1, DL2, DL3, DL4, DL5, and DL6 connected to one charge share line CSL1, CSL2, CSL3, and CSL4 can share a voltage charged during a predetermined charge share period. Through the charge share, voltages of the data lines DL1, DL2, DL3, DL4, DL5, and DL6 charged to a relatively high voltage value can be applied to the data lines DL1, DL2, DL3, DL4, DL5, and DL6 charged to a relatively low voltage value. After the charge share, voltages of the data lines DL1, DL2, DL3, DL4, DL5, and DL6 connected to one charge share line CSL1, CSL2, CSL3, and CSLA can converge to an average value of voltages charged before the charge share.

After the charge share, the data lines DL1, DL2, DL3, DLA, DL5, and DL6 can quickly reach a required voltage. In particular, the data lines DL1, DL2, DL3, DL4, DL5, and DL6 which must be charged to a high voltage value in response to a high grayscale can be charged to a desired voltage value through the charge share. In addition, the data lines DL1, DL2, DL3, DL4, DL5, and DL6 are charged in advance to a predetermined voltage value through the charge share, therefore, a voltage required for reaching a desired voltage value after the charge share is reduced. Through this configuration, power consumption of the source drive IC SDIC can be efficiently reduced.

The calculation unit 35 can generate a control signal CS based on a grayscale value of image data DATA output from the latch unit 321 and 322. The control signal CS can be, for example, a signal having a predetermined voltage or logic level for turning on or turning off the charge share switching element SW11 to SW64 of the charge share circuit 36′.

In more detail, the calculation unit 35 can select at least one data line DL1, DL2, DL3, DL4, DL5, and DL6 subjected to fulfillment of the charge share based on a grayscale value of image data DATA output from the first latch unit 321. The calculation unit 35 can output the control signal CS to the charge share switching elements SW11 to SW64 so that the selected data lines DL1, DL2, DL3, DL4, DL5, and DL6 are connected to the same charge share line CSL1, CSL2, CSL3, and CSL4.

In an embodiment, the calculation unit 35 can define a plurality of grayscale regions, and operate the data lines DL1, DL2, DL3, DL4, DL5, and DL6 to which image data DATA in the same grayscale region is output in the charge share mode. The plurality of grayscale regions can be defined to include one or more grayscale values between a smallest grayscale value and a greatest grayscale value, including the smallest grayscale value and the greatest grayscale value.

For example, the plurality of grayscale regions can include four grayscale regions, as illustrated in FIG. 6. Now, a first grayscale region A1 (a low grayscale region) includes Oth grayscale to 62nd grayscale, a second grayscale region A2 includes 63rd grayscale to 126th grayscale, a third grayscale region A3 includes 127th grayscale to 190th grayscale, and a fourth grayscale region A4 includes 191st grayscale to 255th grayscale.

However, the grayscale region is not limited to what is illustrated in FIG. 6. In various other embodiments of the present disclosure, the grayscale regions can be defined to be provided in a fewer or a greater quantity than what is illustrated. Each of the grayscale regions can be configured to include the same or different quantity of grayscale values.

In an embodiment, the calculation unit 35 can determine into which grayscale region a grayscale value of image data DATA output from the first latch unit 321 is included. The calculation unit 35 can operate the data lines DL1, DL2, DL3, DLA, DL5, and DL6 to which image data DATA of the same grayscale region is applied in the charge share mode.

For example, the calculation unit 35 can control the charge share switching elements SW11 to SW61 to connect the data lines DL1, DL2, DL3, DL4, DL5, and DL6 to which image data DATA of the first grayscale region A1, illustrated in FIG. 6, is applied to the first charge share line CSL1. In addition, the calculation unit 35 can control the charge share switching elements SW12 to SW62 to connect the data lines DL1, DL2, DL3, DL4, DL5, and DL6 to which image data DATA of the second grayscale region A2 is applied to the second charge share line CSL2. Moreover, the calculation unit 35 can control the charge share switching elements SW13 to SW63 to connect the data lines DL1, DL2, DL3, DL4, DL5, and DL6 to which image data DATA of the third grayscale region A3 is applied to the third charge share line CSL3. Furthermore, the calculation unit 35 can control the charge share switching elements SW 14 to SW64 to connect the data lines DL1, DL2, DL3, DL4, DL5, and DL6 to which image data DATA of the fourth grayscale region A4 is applied to the fourth charge share line CSL4. However, the embodiments of the present disclosure are not limited thereto.

In an embodiment, the calculation unit 35 can determine into which grayscale region a grayscale value of image data DATA continuously output from the first latch unit 321 is included, and determine whether to perform the charge share with respect to the next image data DATA based on a grayscale region of the previous image data DATA. Alternatively, the calculation unit 35 can determine whether to perform the charge share based on a change of the grayscale region of the image data DATA continuously output.

Those of ordinary skill in the art will recognize that the present disclosure can be embodied in other specific forms without departing from its spirit or essential characteristics. The described embodiments are to be considered in all respects only as illustrative and not restrictive. The scope of the present disclosure is therefore indicated by the appended claims rather than by the foregoing description. All changes which come within meaning and range of equivalency of the claims are to be embraced within the scope of the present disclosure.

### REFERENCE NUMERALS

1: display device
10: timing controller
20: gate driver
30: data driver
40: power supply unit
50: display panel

What is claimed is:

1. A data driver, comprising:
a register unit configured to sample and output image data input sequentially in each horizontal period;
a latch unit configured to latch the image data output from the register unit and output the image data in synchronization with a latch output control signal;
a digital-to-analog converter configured to convert the image data output from the latch unit into a gamma compensation voltage so as to generate data voltages;
a plurality of output buffers configured to sequentially output the data voltages generated by the digital-to-analog converter to data lines;
buffer switching elements connecting the output buffers to the data lines, respectively, in response to a source output enable signal;
a charge share circuit configured to control a connection between at least one charge share line and the data lines; and
a calculation unit configured to output a control signal for controlling the charge share circuit based on a grayscale value of the image data output by the latch unit.

2. The data driver of claim 1,
wherein the charge share circuit includes:
the at least one charge share line; and
at least one charge share switching element connected between the at least one charge share line and the data lines, and
wherein each of the charge share switching element connects a corresponding data line to a corresponding charge share line in response to the control signal in a turn-on level.

3. The data driver of claim 2,
wherein the each of the charge share switching element is connected between the corresponding data line and the corresponding charge share line, and is configured as a transistor having a gate electrode thereof connected to the calculation unit and configured to receive the control signal.

4. The data driver of claim 2,
wherein the calculation unit selects at least one data line to operate in a charge share mode based on the grayscale value of the image data, and outputs the control signal in the turn-on level to charge share switching elements connected to the selected data line.

5. The data driver of claim 4,
wherein the calculation unit defines a plurality of grayscale regions, selects image data of which the grayscale value is included in a same grayscale region, and controls the charge share switching elements to connect data lines to which the selected image data is to be applied to a same charge share line.

6. The data driver of claim 5,
wherein the calculation unit selects image data of which the grayscale value is included in a high grayscale region and a low grayscale region, and controls the charge share switching elements to connect the data lines to which the selected image data is to be applied to a same charge share line.

7. The data driver of claim 5,
wherein when a grayscale value of a previous image data and a grayscale value of a next image data among the image data input sequentially are included in different grayscale regions, the calculation unit operates a data line to which the next image is to be applied in the charge share mode.

8. The data driver of claim 5,
wherein when a grayscale value of a previous image data is included in a high grayscale region and a grayscale value of a next image data is included in a low grayscale region among the image data input sequentially, the calculation unit operates a data line to which the next image data is to be applied in the charge share mode.

9. The data driver of claim 5,
wherein when a grayscale value of a previous image data is included in a low grayscale region and a grayscale value of a next image data is included in a high grayscale region among the image data input sequentially, the calculation unit operates a data line to which the next image data is to be applied in the charge share mode.

10. The data driver of claim 5,
wherein in an (n−1)th horizontal period, data voltages corresponding to an (n−1)-th image data is applied to the data lines, where n is a natural number equal to or greater than 2,
wherein in a charge share period, a voltage is redistributed among the data lines connected to the same charge share line, and
wherein in an n-th horizontal period, data voltages corresponding to a difference between a voltage corresponding to an n-th image data and the redistributed voltage are applied to the data lines.

11. The data driver of claim 10,
wherein in the charge share period, the data lines connected to the same charge share line are charged to an average value of voltages charged to the data lines connected to the same charge share line in the (n−1)th horizontal period.

12. The data driver of claim 10,
wherein in the (n−1)th horizontal period, the source output enable signal in a turn-on level is applied,
wherein in the charge share period, the source output enable signal in a turn-off level is applied, and
wherein in the n-th horizontal period, the source output enable signal in the turn-on level is applied.

13. The data driver of claim 5,
wherein at least one charge share line is provided in correspondence with a quantity of the plurality of grayscale regions.

14. A display device, comprising:
a display panel having an arrangement of pixels;
a data driver configured to apply data voltages to the pixels through data lines;
a gate driver configured to apply scan signals to the pixels through scan lines; and
a timing controller configured to apply image data and a data driving control signal to the data driver,
wherein the data driver comprises:
a register unit configured to sample and output the image data;
a latch unit configured to latch the image data output from the register unit and output the image data in synchronization with a latch output control signal;
a digital-to-analog converter configured to convert the image data output from the latch unit into a gamma compensation voltage so as to generate data voltages;
output buffers configured to sequentially output the data voltages generated by the digital-to-analog converter to the data lines;
buffer switching elements connecting the output buffers to the data lines, respectively, in response to a source output enable signal;
a charge share circuit having charge share switching elements configured to control a connection between at least one charge share line and the data lines; and
a calculation unit configured to output a control signal for controlling the charge share switching elements based on a grayscale value of the image data output by the latch unit.

15. The display device of claim 14,
wherein the calculation unit defines a plurality of grayscale regions, selects image data of which the grayscale value is included in a same grayscale region, and controls the charge share switching elements to connect data lines to which the selected image data is to be applied to a same charge share line.

16. The display device of claim 15,
wherein the calculation unit selects image data of which the grayscale value is included in a high grayscale region and a low grayscale region, and controls the charge share switching elements to connect the data lines to which the selected image data is to be applied to a same charge share line.

17. The display device of claim 15,
wherein when a grayscale value of a previous image data and a grayscale value of a next image data among the image data input sequentially are included in different grayscale regions, the calculation unit controls the charge share switching elements to connect a data line to which the next image data is to be applied to one among the charge chare lines.

18. The display device of claim 15,
wherein when a grayscale value of a previous image data is included in a high grayscale region and a grayscale value of a next image data is included in a low grayscale region among the image data input sequentially, the calculation unit controls the charge share switching elements to connect a data line to which the next image data is to be applied to one among the charge share lines, and
wherein when a grayscale value of a previous image data is included in a low grayscale region and a grayscale value of a next image data is included in a high grayscale region among the image data input sequentially, the calculation unit controls the charge share switching elements to connect a data line to which the next image data is to be applied to one among the charge share lines.
